(19) United States
(12) Patent Application Publication
(10) Pub. No.: US 2013/0265485 A1
(43) Pub. Date: Oct. 10, 2013

(54) PLENOPTIC CAMERA APPARATUS

(71) Applicant: SAMSUNG ELECTRONICS CO., LTD., Gyeonggi-do (KR)

(72) Inventor: Byung-Kwon KANG, Gyeonggi-do (KR)

(73) Assignee: Samsung Electronics Co., Ltd., Gyeonggi-do (KR)

(21) Appl. No.: 13/826,157

(22) Filed: Mar. 14, 2013

(30) Foreign Application Priority Data
Apr. 4, 2012 (KR) 10-2012-0035004

(51) Int. Cl. H04N 5/225

(52) U.S. Cl. CPC H04N 5/225
USPC 348/360

(57) ABSTRACT

A plenoptic camera apparatus includes a main lens unit configured to collect rays emitted from a subject. The plenoptic camera apparatus includes an image sensor unit adapted to capture images formed from the collected rays through one or more convertible lens device units. The convertible lens device units are positioned between the main lens unit and the image sensor unit and configured to provide individual curvature adjustment. The plenoptic camera apparatus includes a control unit configured to control the convertible lens device units to switch to a high-resolution imaging lens or a plenoptic imaging lens array, based on a user's selection, and control driving of the convertible lens device units to compensate for a partial aberration caused by the main lens unit.

### PRIORITY

This application claims priority under 35 U.S.C. §119(a) to a Korean Patent Application filed in the Korean Industrial Property Office on Apr. 4, 2012 and assigned Ser. No. 10-2012-0035004, the contents of which are incorporated herein by reference.

### BACKGROUND OF THE INVENTION

1. Field of the Invention

The present invention relates generally to a plenoptic camera apparatus, and more particularly, to a plenoptic camera apparatus providing high-resolution imaging and plenoptic imaging.

2. Description of the Related Art

Conventional commercialized imaging systems provide only one image from a single imaging operation. A plenoptic camera has recently been developed, which has a function of recombining foci.

The plenoptic camera, also referred to as a light field camera, employs a microlens array or a light-coded mask to capture 4D light field information.

The plenoptic camera allows the user to change the focus plane after an imaging operation. The plenoptic camera also has a view variation function, which gives the impression that scenes are viewed from multiple angles.

Referring to FIG. 1, the plenoptic camera 1 includes a main lens 3 for collecting rays Al spreading from a subject 2, an image sensor 5 for obtaining respective images formed from the rays Al through one or more microlens arrays 4. The microlens arrays 4 are positioned between the main lens 3 and the image sensor 5. The rays Al are collected by the main lens 3 to form images and the images are overlapped in an array type.

Referring to FIG. 1, rays A1 refer to reflected and spreading rays to the subject by exterior rays flowing from the outside. That is, the arrow (↑) illustrated in FIG. 1 represents the exterior rays which enter inside by lighting the subject 2, and A1 illustrated in FIG. 1 represents the rays which radiate by contacting and reflecting the exterior rays to the surface of the subject. As such, the arrow (↑) refers to the exterior rays entering into the subject, and A1 refers to the rays radiating from the subject by reflection to the subject of the exterior rays.

The microlens arrays 4 direct the rays A1 from the subject 2, which correspond to respective angles, to the corresponding areas of the image sensor 5 to create images. In other words, the image sensor 5 forms multiple subject images using respective microlens arrays.

The microlens arrays 4 can extract image portions, which correspond to the rays A1 of the corresponding angles, and combine them into images of different foci or express them as stereoscopic images.

Relevant construction of a plenoptic camera is disclosed in Korean Laid-Open Application No. 10-2009-0016453, the contents of which are incorporated herein by reference.

The conventional plenoptic camera, however, has limitations. Specifically, microlens arrays are arranged between the main lens and the image sensor, such that images formed by the microlens arrays are both overlapped in an array type and captured by the image sensor. Thus, the overlapping of images captured by the image sensor degrades the resolution.

Therefore, there is a need for a plenoptic camera apparatus adapted to enable the user to select between high-resolution imaging and plenoptic imaging as desired.

### SUMMARY OF THE INVENTION

Accordingly, embodiments of the present invention have been made to solve the above-stated problems occurring in the prior art. Specifically, a plenoptic camera apparatus is configured to switch between a lens for high-resolution imaging and a lens array for plenoptic imaging so that the user can perform high-resolution imaging, as well as plenoptic imaging in special environments and scenes.

Further, the plenoptic camera apparatus is configured to switch between a lens for high-resolution imaging and a lens array for plenoptic imaging so that, besides preventing degradation of resolution as in the case of conventional plenoptic cameras, the plenoptic camera apparatus can also be used for high-resolution imaging.

In accordance with an aspect of the present invention, there is provided a plenoptic camera apparatus. The plenoptic camera apparatus includes a main lens unit configured to collect rays emitted from a subject and an image sensor unit adapted to capture images formed from the collected rays through one or more convertible lens device units. The convertible lens device units are positioned between the main lens unit and the image sensor unit and configured to provide individual curvature adjustment. The plenoptic camera apparatus further includes a control unit configured to control the convertible lens device units to switch to a high-resolution imaging lens or a plenoptic imaging lens array, based on a user's selection, and control driving of the convertible lens device units to compensate for a partial aberration caused by the main lens unit.

In accordance with an aspect of the present invention, there is provided a plenoptic camera apparatus. The plenoptic camera apparatus includes a first optical unit configured to collect rays emitted from a subject and an image sensor unit configured to capture images. The plenoptic camera apparatus further includes one or more second optical units positioned between the first optical unit and the image sensor unit and configured to switch to a high-resolution imaging lens or a plenoptic imaging lens array and form the images from the collected rays.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates the construction of a conventional plenoptic camera;

FIG. 2 illustrates an exploded perspective view of a plenoptic camera apparatus, according to an embodiment of the present invention;

FIG. 3 illustrates a plenoptic camera apparatus, according to an embodiment of the present invention;

FIG. 4 illustrates a high-resolution imaging function of a liquid lens device of a plenoptic camera apparatus, according to an embodiment of the present invention;

FIG. 5 illustrates a plenoptic imaging function of a liquid lens device of a plenoptic camera apparatus, according to an embodiment of the present invention;

FIG. 6 illustrates a liquid crystal lens device of a plenoptic camera apparatus, according to an embodiment of the present invention;

FIG. 7 illustrates the operation of a liquid crystal lens device of a plenoptic camera apparatus, according to an embodiment of the present invention; and

FIG. 8 illustrates the operation of a shape-changing liquid lens device of a plenoptic camera apparatus, according to an embodiment of the present invention.

### DETAILED DESCRIPTION EMBODIMENTS OF THE PRESENT INVENTION

Hereinafter, embodiments of the present invention are described with reference to the accompanying drawings. Further, various specific definitions found in the following description are provided only to help general understanding of the present invention, and it will be understood by those skilled in the art that various changes and modifications can be made thereto within the technical spirit and scope of the present invention. In the following description, a detailed explanation of known related functions and constitutions may be omitted to avoid unnecessarily obscuring the subject matter of the present invention.

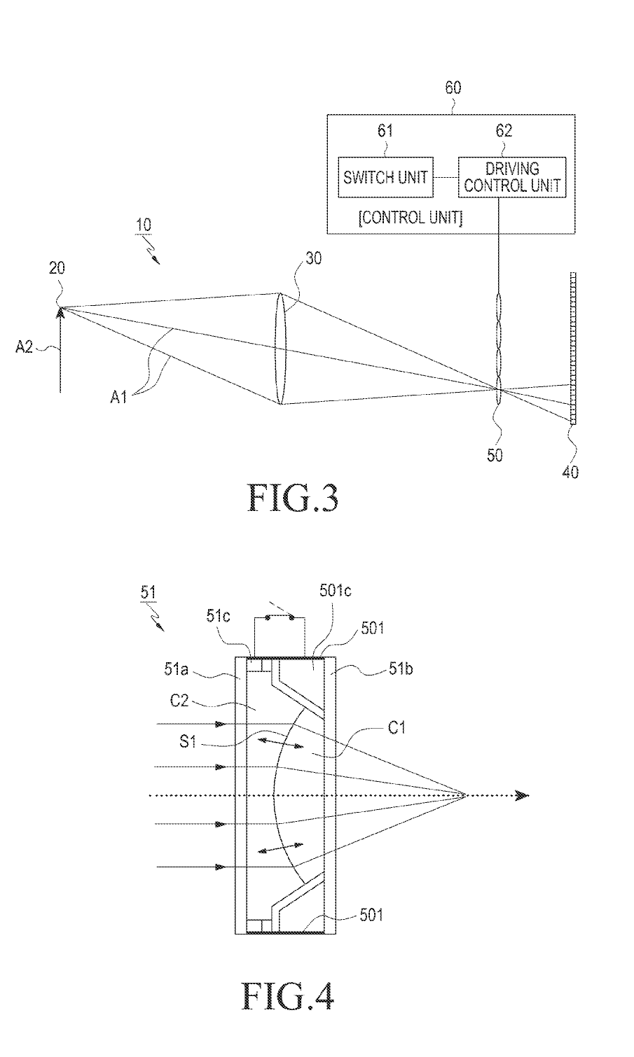

FIGS. 2 and 3 illustrate the construction of a plenoptic camera apparatus according to an embodiment of the present invention.

The plenoptic camera apparatus 10 includes a main lens unit 30, an image sensor unit 40, one or more convertible lens device units 50, and a control unit 60. The main lens unit 30 is configured to collect rays Al emitted from a subject 20. The image sensor unit 40 is positioned behind the convertible lens device units 50 so that one or more images are formed through the convertible lens device units 50 from the rays A1 collected by the main lens unit 30, and the formed images are captured.

The convertible lens device units 50 are positioned between the main lens unit 30 and the image sensor unit 40. The convertible lens device units 50 are adapted to switch between a lens for high-resolution imaging and lens arrays for plenoptic imaging and may adjust a curvature of the lens or the lens arrays individually. The control unit 60 is electrically connected to the convertible lens device units 50 to control driving of the convertible lens device units 50. Specifically, based on the user's selection, the convertible lens device units 50 can switch between a high-resolution imaging lens and plenoptic imaging lens arrays, compensating for a partial aberration caused by the main lens unit 30.

As used herein, the aberration occurring in the main lens unit 30 refers to blurring or deforming of images.

Therefore, the control unit 60 controls the driving of the convertible lens device units 50 to correct blurring or deforming of images caused by the main lens unit 30. Thus, clear high-resolution images are obtained.

As illustrated by FIG. 3, the control unit 60 includes a switch unit 61 and a driving control unit 62. The switch unit 61 is configured to allow the user to select between a high-resolution imaging function and a plenoptic imaging function. The driving control unit 62 is configured to control so that the convertible lens device units 50 are driven for the high-resolution imaging function or the plenoptic imaging function based on the user's selection made through the switch unit 61.

Specifically, when the user wants to use the plenoptic camera apparatus 10 for high-resolution imaging, the user selects the high-resolution imaging function using the switch unit 61. The switch unit 61 then applies a high-resolution imaging function signal to the driving control unit 62. The driving control unit 62 applies a high-resolution imaging voltage to the convertible lens device units 50 to drive the convertible lens device units 50 upon receiving the high-resolution imaging function signal from the switch unit 61.

The convertible lens device units 50 are driven by the driving control unit 62 for the high-resolution imaging function to form high-resolution images, which are captured by the image sensor unit 40.

Referring to FIG. 3, when the user wants to use the plenoptic camera apparatus for plenoptic imaging, the user selects the plenoptic imaging function using the switch unit 61. The switch unit 61 then applies a plenoptic imaging function signal to the driving control unit 62. The driving control unit 62 applies a plenoptic imaging voltage to the convertible lens device units 50 to drive the convertible lens device units 50 upon receiving the plenoptic imaging function signal from the switch unit 61.

The convertible lens device units 50 are driven by the driving control unit 62 for the plenoptic imaging function to form plenoptic images, which are captured by the image sensor unit 40.

The convertible lens device units 50 preferably include, in order to adjust the curvature of the lens and the lens arrays, at least one of a liquid lens device 51, a liquid crystal lens device 52, and a shape-changing liquid lens device 53. The convertible lens device units 50 may also include other types of lens devices than the enumerated ones.

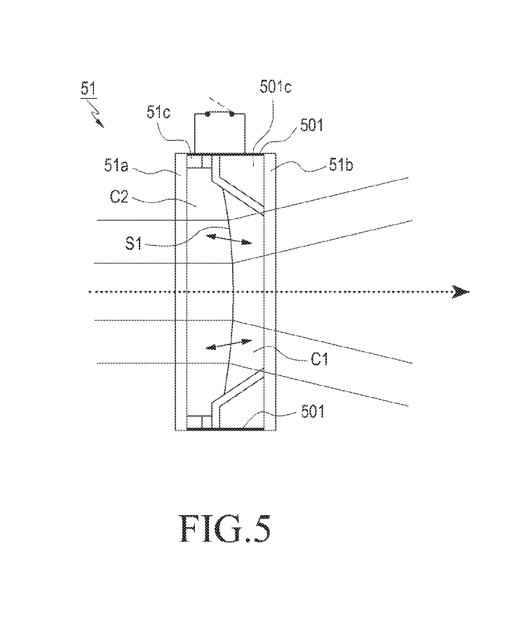

FIGS. 4 and 5 illustrate a high-resolution imaging function of the liquid lens device 51, and a plenoptic imaging function of the liquid lens device 51, respectively, of the convertible lens device units 50.

The liquid lens device 51, as shown in FIGS. 4 and 5, has transparent substrates 51a and 51b attached to a bottom and a top of a cylinder, respectively. A space between the upper and lower transparent substrates 51a and 51b is filled with two types of liquids, which have different refractive indices and which do not mix with each other. One of the two types of liquids is oil C1 having insulating and nonpolar characteristics (such as cooking oil, which does not include electrolytes and does not conduct electricity), and the other is an electrically conductive aqueous solution C2 (such as salt water, which is an electrolyte itself and conducts electricity). The cylinder has an electrically conductive electrode and insulating coating thereon. An electrode 51c having a polarity opposite to the electrically conductive electrode is installed near the substrate 51 a of the conductive aqueous solution C2 so that, by connecting the conductive aqueous solution C2 and the electrode 51c of the transparent substrates 51a and 51b, the structure of the liquid lens device 51 constitutes a capacitor. Application of a voltage to the liquid lens device 51 changes the surface tension of the conductive aqueous solution C2. The curvature between the two liquids C1 and C2 is adjusted in response to the application of the voltage.

The switch unit 61 of the control unit 60 applies a high-resolution imaging function signal to the driving control unit 62, which then applies a high-resolution imaging voltage to the liquid lens device 51 when the user selects the high-resolution imaging function using the switch unit 61 of the control unit 60.

That is, as shown in FIG. 4, the liquid lens device 51 changes (adjusts) the curvature between the conductive aqueous solution C2 and oil C1, thus adjusting the focal length. Then, the rays Al collected by the main lens unit 30 (shown in FIG. 3) pass through the liquid lens device 51 to form high-resolution images, which are captured by the image sensor unit 40.

In this manner, the plenoptic camera apparatus 10 may be used as a conventional high-resolution camera.

On the other hand, when the user selects the plenoptic imaging function using the switch unit 61 of the control unit 60, a plenoptic imaging function signal is applied to the driving control unit 62, which then applies a plenoptic imaging voltage to the liquid lens device 51.

As shown in FIG. 5, the liquid lens device 51 changes (adjusts) the curvature between the conductive aqueous solution C2 and oil C1 to enable plenoptic imaging. The liquid lens device 51, in this case, includes of one or more lens arrays. Then, the rays Al collected by the main lens unit 30 (shown in FIG. 3) pass through the liquid lens devices 51 to form one or more images, which are captured by the image sensor unit 40.

In this manner, the plenoptic camera apparatus 10 may be used as a plenoptic camera.

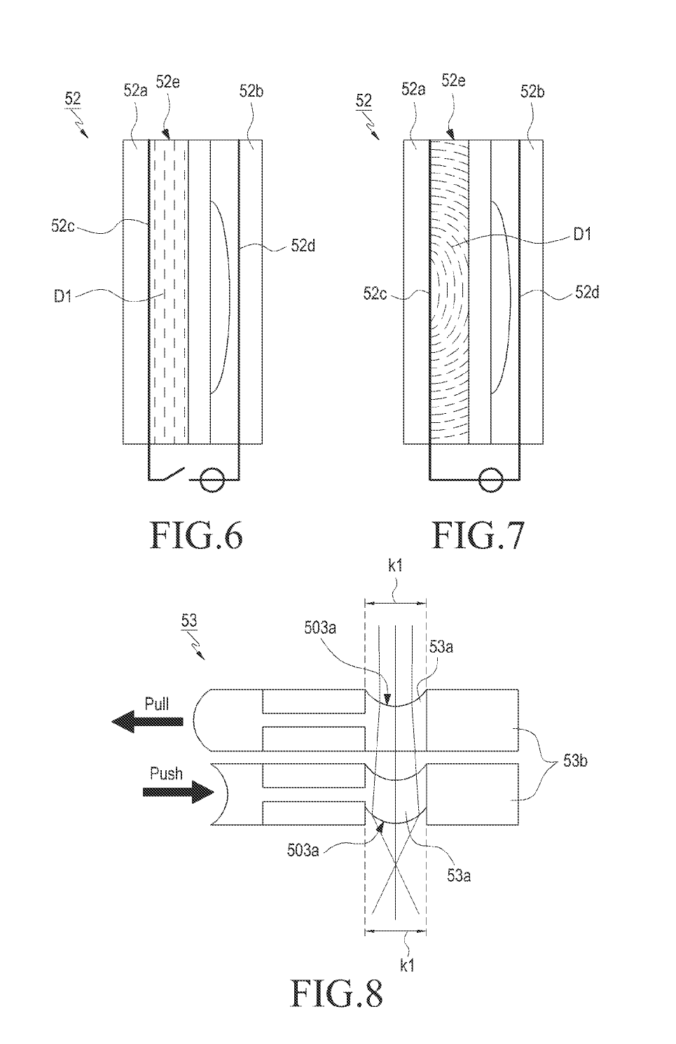

FIG. 6 illustrates a liquid crystal device including a convertible lens device unit prior to operation, and FIG. 7 illustrates the liquid crystal lens device including the convertible lens device unit during operation.

The liquid crystal lens device 52, as shown in FIGS. 6 and 7, includes first and second transparent substrates 52a and 52b, first and second electrodes 52c and 52d provided on the first and second transparent substrates 52a and 52b for voltage driving, liquid crystal molecules D1, and a liquid crystal orientation layer 52e formed on the first and second electrodes to orient the liquid crystals D1. The liquid crystal molecules D1 have a circular pattern. When the liquid crystal molecules D1 drive together with the first and second electrodes 52a and 52b by a voltage applied from the outside, an electric potential difference creates an angle in the liquid crystal molecules D1, and a phase difference generated in the liquid crystal molecules D1 causes the liquid crystal to act as a lens.

That is, when the applied voltage changes the arrangement of the liquid crystal molecules D1 of the liquid crystal lens device 52, the refractive index of the liquid crystal layer 52e changes, and the focal length is adjusted.

The switch unit 61 of the control unit 60 applies a high-resolution imaging function signal to the driving control unit 62, which then applies a high-resolution imaging voltage to the liquid crystal lens device 52 when the user selects the high-resolution imaging function using the switch unit 61 of the control unit 60.

That is, as shown in FIG. 7, the liquid crystal lens device 52 modifies the arrangement of the liquid crystal molecules D1 by the high-resolution imaging voltage to both change the refractive index of the liquid crystal layer 52e and adjust the focal length. Then, the rays Al collected by the main lens unit 30 (shown in FIG. 3) pass through the liquid crystal lens device 52 to form high-resolution images, which are captured by the image sensor unit 40.

In this manner, the plenoptic camera apparatus 10 can be used as a high-resolution camera to provide the user with high-resolution images.

On the other hand, when the user selects the plenoptic imaging function using the switch unit 61 of the control unit 60 a plenoptic imaging function signal is applied to the driving control unit 62, which then applies a plenoptic imaging voltage to the liquid crystal lens device 52.

As shown in FIG. 7, the liquid crystal lens device 52 modifies the arrangement of the liquid crystal molecules D1 by the plenoptic imaging voltage to both change the refractive index of the liquid crystal layer 52e and adjust the focal length. The liquid crystal lens device 52, in this case, includes one or more lens arrays. Then, the rays A1 collected by the main lens unit 30 (shown in FIG. 3) pass through the liquid crystal lens device 52 to form one or more images, which are captured by the image sensor unit 40.

In this manner, the plenoptic camera apparatus 10 can be used as a plenoptic camera and provide the user with 4D images.

FIG. 8 illustrates the operation of a shape-changing liquid lens device including a convertible lens device unit.

The shape-changing liquid lens device 53, as shown in FIG. 8, has an area defined on a substrate 53b to constitute a lens and the area is filled with a liquid so that the shape can be varied by pressure change. Furthermore, the curvature of the surface shape of the liquid increases or decreases accordingly, so that the focal length of the lens is adjusted.

The switch unit 61 of the control unit 60 applies a high-resolution imaging function signal to the driving control unit 62, which then applies a high-resolution imaging voltage to the shape-changing liquid lens device when the user selects the high-resolution imaging function using the switch unit 61 of the control unit 60.

That is, as shown in FIG. 8, the shape-changing liquid lens device 53 defines an area containing a liquid 53a. The shape-changing liquid lens device 53 applies pressure to the substrate 53b and to the liquid 53a on the substrate 53b to both change (adjust) the curvature and adjust the focal length. Then, the rays Al collected by the main lens unit (shown in FIG. 3) pass through the shape-changing liquid lens device 53 to form high-resolution images, which are captured by the image sensor unit 40.

On the other hand, when the user selects the plenoptic imaging function using the switch unit 61 of the control unit 60a plenoptic imaging function signal is applied to the driving control unit 62, which then applies a plenoptic imaging voltage to the shape-changing liquid lens device.

As shown in FIG. 8, the shape-changing liquid lens device 53 applies pressure to the liquid 53a to change (adjust) the curvature of the substrate 53b so that plenoptic imaging is possible. The shape-changing liquid lens device 53 includes one or more lens arrays. Then, the rays A1 collected by the main lens unit 30 (shown in FIG. 3) pass through the shape-changing liquid lens devices 53 to form a number of images, which are captured by the image sensor unit 40.

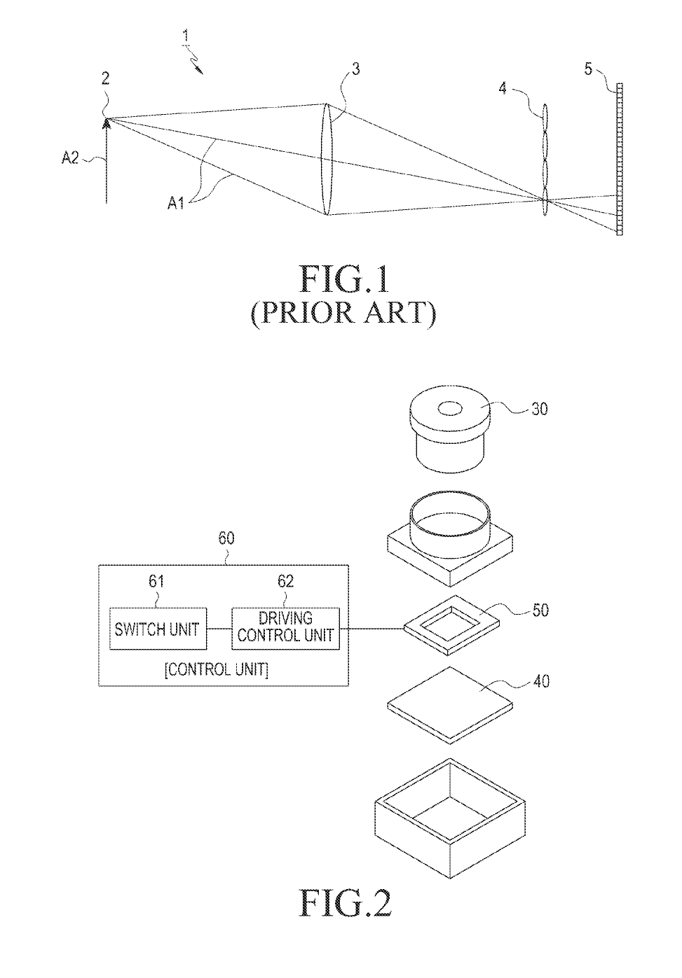

As described above, the conventional plenoptic camera 1 (shown in FIG. 1) is limited in that rays collected by the main lens pass through one or more microlens arrays 4 (shown in FIG. 1) to form respective images, which are overlapped in an array type, such that overlapping of images degrades the resolution.

In order to solve this problem, embodiments of the present invention provide a plenoptic camera apparatus including one or more convertible lens device units 50. The plenoptic camera apparatus provides either high-resolution imaging or plenoptic imaging, and includes a control unit 60 so that the user can select high-resolution imaging, as well as plenoptic imaging in special environments and scenes, to obtain 4D images.

Meanwhile, the plenoptic camera apparatus 10 (shown in FIG. 3) according to an embodiment of the present invention is applicable to an electronic device, as a typical example. However, those skilled in the art can understand that the present invention is not limited to electronic devices, but are applicable to various types of devices.

Examples of the various types of electronic devices, to which embodiments of the present invention are applicable, include all kinds of information communication devices, multimedia devices, and related application devices. Specifically, all kinds of mobile communication terminals operating based on communication protocols corresponding to various communication systems, digital cameras, MP3 players, Portable Multimedia Players (PMPs), navigation devices, game consoles, laptops, billboards, TV sets, digital broadcast players, Personal Digital Assistants (PDAs), and smart phones.

While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. A plenoptic camera apparatus comprising:
a main lens unit configured to collect rays emitted from a subject;
an image sensor unit configured to capture images formed from the collected rays through one or more convertible lens device units;
the convertible lens device units positioned between the main lens unit and the image sensor unit and configured to provide individual curvature adjustment; and
a control unit configured to control the convertible lens device units to switch to a high-resolution imaging lens or a plenoptic imaging lens array, based on a user's selection, and control driving of the convertible lens device units to compensate for a partial aberration caused by the main lens unit.

2. The plenoptic camera apparatus as claimed in claim 1, wherein the convertible lens device units comprise at least one of a liquid lens device, a liquid crystal lens device, and a shape-changing liquid lens device.

3. The plenoptic camera apparatus as claimed in claim 1, wherein the control unit comprises:
a switch unit configured to enable selection between a high-resolution imaging function and a plenoptic imaging function; and
a driving control unit configured to control driving of the convertible lens device units based on selection made by the switch unit.

4. The plenoptic camera apparatus as claimed in claim 3, wherein the switch unit is configured to distinguish between a high-resolution imaging function signal and a plenoptic imaging function signal and apply the high-resolution imaging function signal and the plenoptic imaging function signal to the driving control unit.

5. The plenoptic camera apparatus as claimed in claim 4, wherein the driving control unit is configured to receive the high-resolution imaging function signal or the plenoptic imaging function signal, the high-resolution imaging function signal and the plenoptic imaging function signal being selected by the switch unit, and drive the convertible lens device units by a high-resolution imaging voltage or a plenoptic imaging voltage.

6. The plenoptic camera apparatus as claimed in claim 4, wherein the driving control unit is configured to control driving of the convertible lens device units to compensate for an aberration caused by the main lens unit.

7. A plenoptic camera apparatus comprising:
a first optical unit configured to collect rays emitted from a subject;
an image sensor unit configured to capture images; and
one or more second optical units positioned between the first optical unit and the image sensor unit and configured to switch to a high-resolution imaging lens or a plenoptic imaging lens array and form the images from the collected rays.

8. The plenoptic camera apparatus as claimed in claim 7, wherein the first optical unit comprises a main lens unit.

9. The plenoptic camera apparatus as claimed in claim 7, wherein the second optical units further comprise a control unit configured to control the second optical units to switch to a high-resolution imaging lens or a plenoptic imaging lens array based on a user's selection.
